(19) United States
(12) Patent Application Publication
(10) Pub. No.: US 2008/0136408 A1
(43) Pub. Date: Jun. 12, 2008

(54) Assembly and Method For Locating Magnetic Objects or Objects That Can Be Magnetized

(75) Inventors: Wilfried Andra, Jena (DE); Holger Lausch, Jena (DE)

Correspondence Address: JORDAN AND HAMBURG LLP, 122 EAST 42ND STREET, SUITE 4000, NEW YORK, NY, 10168, US

(73) Assignee: Displaycom Track Technologies GmbH, Jena (DE)

(21) Appl. No.: 11/793,637

(22) PCT Filed: Nov. 29, 2005
(86) PCT No.: PCT/DE2005/002167

§ 371 Date: Jun. 20, 2007

(30) Foreign Application Priority Data
Dec. 20, 2004 (DE) 10 2004 062 181.0
Jun. 7, 2005 (DE) 10 2005 026 676.2

(51) Int. Cl. G01N 27/72

(52) U.S. Cl. 324/239; 324/228

(57) ABSTRACT

Disclosed is an assembly and method for locating magnetic objects or objects that can be magnetized, with the objects being located in non-magnetic media. To increase the detection depth for such objects and to clearly register their shape, position and structures on single detection planes, at least one sensor is arranged in a primary magnetic field of a magnetic field generator and the magnetization distribution of the magnetic field is uniform in the vicinity of the corresponding senor or its local profile is known.

### BACKGROUND OF THE INVENTION

The invention relates to an assembly and method for locating magnetic objects or objects that can be magnetized, according to the species of the claims, with these objects being situated in non-magnetic media and neither being accessible by optical nor mechanical methods, for example. This localization includes e.g. the determination of the position, form and orientation of steel reinforcement elements in concrete or the detection of steel girders in brickwork or ground or the determination of ship anchors in ocean floor, just to mention only some fields of application.

Different methods are known for locating steel elements in concrete. Among them, the magnetic procedures have been particularly used both as continuous field and alternating field methods.

In the continuous field method, either the force acting between the reinforcing element and a permanent magnet located outside the concrete is measured or the magnetic stray field of the reinforcing element magnetized by a permanent magnet is measured; see [1] of the reference literature list at the end of this description. The disadvantage of the force measuring procedure is that the force considerably decreases with the increase of the distance and therefore it is not possible to detect low-lying reinforcing elements. In the stray field method, the magnetic stray field of the reinforcing element is superimposed by the magnetic field of the permanent magnet that is generally much stronger than the stray field and therefore it can only be eliminated from the stray field to be measured with a relatively large error. Consequently, the two continuous field methods are only applied for an approximate localization of magnetic objects [1].

In the alternative field method, the reinforcing element is magnetized by an alternating magnetic field. In this procedure, electric eddy currents are also excited in the reinforcing element. In any case, an alternating magnetic field is generated that starts from the reinforcing element and for example changes the inductance of a coil that generates the alternating field. Generally, the position of the reinforcing element is found by evaluating the changed complex impedance of an electric circuit that includes the exciting coil for the primary magnetic field [1-5]. The alternating field offers the principal possibility to locate non-magnetic reinforcing elements (e.g. made of special steel), too. For different reasons, e.g. because of the influence of the conductivity of concrete, it has been not possible till now to reliably locate reinforcing elements that are positioned under a concrete layer thicker than 15 cm. Improved evaluating algorithms cannot change this situation either [6, 7].

Apart from magnetic mechanisms also other physically working mechanisms have been used for locating reinforcing elements in concrete bodies, such as ultrasound [8-11], motion and absorption of neutrons [12], infrared reflection [13], radar measurements [14-16] and X-rays or gamma rays [1]. But till now, these working mechanisms have not led to better results than the magnetic means and procedures mentioned above.

### SUMMARY OF THE INVENTION

Therefore, the task of this invention is not only the increase of the detection depth for ferromagnetic objects in non-magnetic media but also the unequivocal recording of their form, position and structure on individual detection planes and the separated recording of the different detection planes.

### BRIEF DESCRIPTION OF THE INVENTION

According to the present invention, this task is solved by the elements of the first patent claim and the subclaims support its further advantageous development and specification. The magnetic field generators can be coils of different shapes and sizes carrying variable electric currents or differently designed permanent magnets or a combination of both of them. The objects to be detected are magnetized by the generated primary magnetic field having a preset field distribution and adjustable strength, including polarization. The magnetic stray field produced by the individual object then is measured by means of a magnetic sensor during the period in which the primary field is active or when it has been switched off. The sensor used must be arranged within the stray field with at least one part that is sensitive to magnetic fields, for example a small magnetic measuring body. The force of the magnetic stray field is acting on said measuring body (generally, in the range of μN) and thus relocates it according to the lines of flux. This relocation can be measured by applying electrical (inductive, capacitive), optical (e.g. interferometric), acoustic or mechanical (indicator system with scale) methods. If the measurement is taken during the activity of the primary magnetic field, the measuring body/bodies must be positioned within the uniform range of the primary magnetic field to eliminate the effect of said field onto the measuring body. In order to locate the magnetic objects or the objects that can be magnetized in non-magnetic media, a system of magnetic field generators, preferably consisting of electric coils, is used and generates a primary magnetic field. The maximum of said field located on the common coil axis can be adjusted and changed at a variable distance from the center plane of the coil system. The area-related localization of magnetic objects in a non-magnetic medium is possible by using a multiple cluster- or matrix-like arrangement of measuring bodies provided side by side on one area. Each measuring body made of a soft or hard magnetic material has preferably an elastic connection to the corresponding magnetic field generator so that it can mainly change its position in small steps perpendicular to the center plane of the magnetic field generator. Favorably, the elastic connection has at least one natural mechanic frequency the excitation of which causes a clear amplitude increase of the excited vibrations of the measuring body. Possibly, one area of the measuring body can be designed as a capacitor electrode.

The magnetic sensor can also be a one-, two- or three-axis magnetometer that is used to determine the characteristic parameters of the geometric distribution of the magnetic stray field of the magnetic object. The ideal magnetometer type to be used depends on the measuring accuracy required and on the acceptable technical efforts. It is principally possible to use either a SQUID (superconducting quantum interference device) or a flux gate or a magnetometer based on the magnetoresistive or Hall effect. It is of importance that the magnetometer volume necessary for measuring stray fields is small compared to the required localization accuracy. Therefore, magnetometers based on the magnetoresistive or Hall effect are to be used preferably.

Instead of measuring the force it is also possible to measure the characteristic parameters of the stray field and to derive the localization (comprising the position, form, orientation, dimension) of magnetic objects (including objects that can be magnetized) from the obtained results. Such characteristic parameters are the orientation and field strength of the stray field that can be measured at one or different positions, which have a known geometric relation to each other, while the magnetized object is in different magnetization conditions. The measurements taken in different magnetization conditions allow the elimination of magnetic background fields, e.g. the earth's field. In the simplest embodiment, the magnetic field components of the stray field measured by at least one magnetometer after the magnetization with the opposite sign are subtracted from each other to eliminate the influence of a background field. The background field itself can be determined by adding the measured magnetic field components after their magnetization with the opposite sign.

As the geometric distribution of the stray field is defined by the position, form and magnetization condition of the object, it is principally possible to determine these first unknown data on the basis of the complete measurement of the field distribution. To a limited extent, it is also possible to determine these data if the measurements are only taken in a subvolume or even at only one position. For simple forms of the object, such as spheres or rods with a very big length, only a few measurements at certain positions are required thanks to the symmetry of the magnetic field distribution.

The method will be extremely easy, if the object can be magnetized uniformly and it therefore exhibits a calculable distribution of magnetic surface charges that can be used to theoretically derive the stray field distribution. Due to the decrease of the strength of the magnetic stray field with the increase of the distance, a non-uniform magnetization distribution can be tolerated in the object, if this distribution can be approximated sufficiently thanks to a uniform distribution in the vicinity of the measuring points or if the local profile of the non-uniformity is known.

The local distribution of primary magnetic fields that are generated by the current-carrying coils can be calculated with any desired precision by applying the law of Biot and Savart. This easy calculation offers an advantage for this kind of field generation. Another advantage is given by the fact that the primary magnetic field can be completely switched off by switching off the currents. Another advantageous feature provided by this method is that the local distribution of the primary magnetic field can be changed by changing the power of the electric currents carried by several coils. Thus, it is for example possible to position the maximum or zero crossing of the primary magnetic field at different positions on the common coil axis of two concentric coils. A useful property of coil fields is also the fact that special coils (bucking coils) fixed close to the magnetometer compensate the primary magnetic field at the localization of the magnetometer thus allowing a higher measuring accuracy.

Permanent magnets should be used preferably, if strong primary magnetic fields are to be generated at longer distances to the magnetometer. Normally, permanent magnets require the electrical power, which is necessary for magnetizing an object, only once and during a short period of time. The energy consumed for this purpose will not be required again for later uses. If the permanent magnets are to be moved for locating purposes, e.g. if they are to be turned to eliminate the background field, considerably less power will be required.

The magnetization distribution of objects can be calculated with the desired accuracy by using commonly known mathematic operations, e.g. the finite element method, if special parameters such as the distribution of the primary field at the position of the objects and the magnetic susceptibility of the objects are known. Unlike the primary field that is always known, the susceptibility of the object is normally not known. But if the objects have simple geometric forms (e.g. spheres or cylinders with a great length-diameter relation), the magnetization distribution will be determined by the so called magnetic form anisotrophy that is characterized by the fact that in magnetic primary fields, in which the objects are sufficiently far away from the condition of magnetic saturation, an almost constant relation exists between the magnetization of the object and the strength of the primary field with the value of said relation being determined by the form of the object. For simple forms, the magnetic form anisotrophy is determined by the so called demagnetization factor that has a value of ⅓ for spheres, ½ for long cylinders (for a magnetization perpendicular to the cylinder axis) or 0 (for a magnetization parallel to the cylinder axis). The calculation of the demagnetization factor for ellipsoidal objects is based on the three axes of the ellipsoids. The calculation will become extremely easy, if the primary field is uniform at the position of the object, that means its orientation and field strength do not depend on the individual position. Then, a uniform distribution of the object magnetization is reached for the simple object forms mentioned above. In practical application, a completely uniform primary field is not required. It will be sufficient, if the primary field in a subvolume of the object used for the calculation of the stray field can be roughly described by a uniform field. This condition is normally given, if the three dimensions of said subvolume are smaller than the diameter of the coils that determine the primary field at the position of the object by more than 50% or, if the subvolume is smaller than the volume of the field-generating permanent magnets, if permanent magnets are used for the field generation.

An essential condition for the calculation of the magnetization distribution is that the stray fields of adjacent objects are much weaker than the primary field. This requirement will be normally met, if the distances between adjacent objects are at least twice as long as the smallest dimension of the objects.

The distribution of the stray field starting from the magnetic poles which is given in the objects due to an existing primary field or due to the remanent magnetization after switching off the primary field can be principally calculated in known mathematical operations for any desired pole distribution. Particularly simple local distributions in the stray fields are the result in cases in which a magnetic monopole or a magnetic dipole or simple dipole distributions (e.g. line dipole) are used. To simplify the calculation it is soften sufficient to calculate the local distribution within limited volumes. Depending on the individual task of localization, the calculation of one field component (e.g. of the component parallel to a primary field coil) as a function of the position on a symmetry axis of this coil can be sufficient to determine the distance between the object and the magnetometer. Another simple situation is the determination of the orientation of the magnetometer relative to an object. In this case it is advantageous to measure the stray field components on one plane perpendicular to the connection axis between the magnetometer and the object.

Alternatively to the calculation of stray fields, empiric methods can be used for localization purposes, such as the creation of a library of stored stray field distributions. Each of the stored stray field distributions consists of a basic distribution and some characteristic parameters that can be used for varying the basic distribution. In most of the localization tasks, the basic distribution can be taken as known. A typical example is the localization of one or several cylindrical reinforcing rods in concrete that are arranged parallel to each other and to the surface of a concrete body. In this example, the characteristic parameters are the thickness of the rods, the distance from the concrete surface, the orientation of the rods and the distance of the rods to each other. A software for managing a parameter library allows the comparison of the stray field values measured at defined positions with the values provided in the library. The characteristic parameters are varied and the parameters that show the best correspondence of the measured values and the library values will be output. For this method it is important that the functional dependence of the library values upon the different parameters, such as the rod thickness and the distance between the rod and the magnetometer, varies. Several sensors, e.g. magnetometers, with a defined position to each other can be used to avoid possible ambiguities that can be caused for example by the fact that a thicker rod lying deeper causes the same stray field values in the sensor (magnetometer) like a thin rod positioned closer to it.

A method for locating magnetic objects or objects that can be magnetized, which are positioned in non-magnetic media, is characterized by the generation of a primary magnetic field by means of coils, electromagnets or permanent magnets that have an effect on the objects. Afterwards, the local distribution of the magnetic stray field of the objects is determined and the amount and the orientation of the magnetic stray field are measured by sensors at defined positions. Finally, the measured values are compared with predetermined values. An electronic method can be applied for this comparison by using stored reference stray fields. The local distribution of the magnetic stray field of the objects can also be realized by determining the gradient of this stray field.

### BRIEF DESCRIPTION OF THE DRAWINGS

In the following, five examples explain the invention in detail in a schematic drawing. They show:

FIG. 1 a first embodiment of the invention with a dynamometer,

FIG. 2 the principal arrangement of measuring bodies and capacitors of a second embodiment of the invention,

FIG. 3 a net-like arrangement of measuring bodies of a third embodiment of the invention,

FIG. 4 the use of one sensor for several measuring bodies in a fourth embodiment of the invention,

FIG. 5 an embodiment with rectangular coils and a magnetometer,

FIG. 6 a diagram illustrating the position of the maximum and zero crossing of the total field relative to the coil axis, if two primary field coils are used,

FIG. 7 a diagram illustrating the position of the maximum and zero crossing of the total field, if two primary field coils and one capacitor coil are used, and

FIG. 8 a diagram illustrating the influence of the relocation of the sensor relative to a magnetic object on the stray field components at the position of the magnetometer.

### DETAILED DESCRIPTION

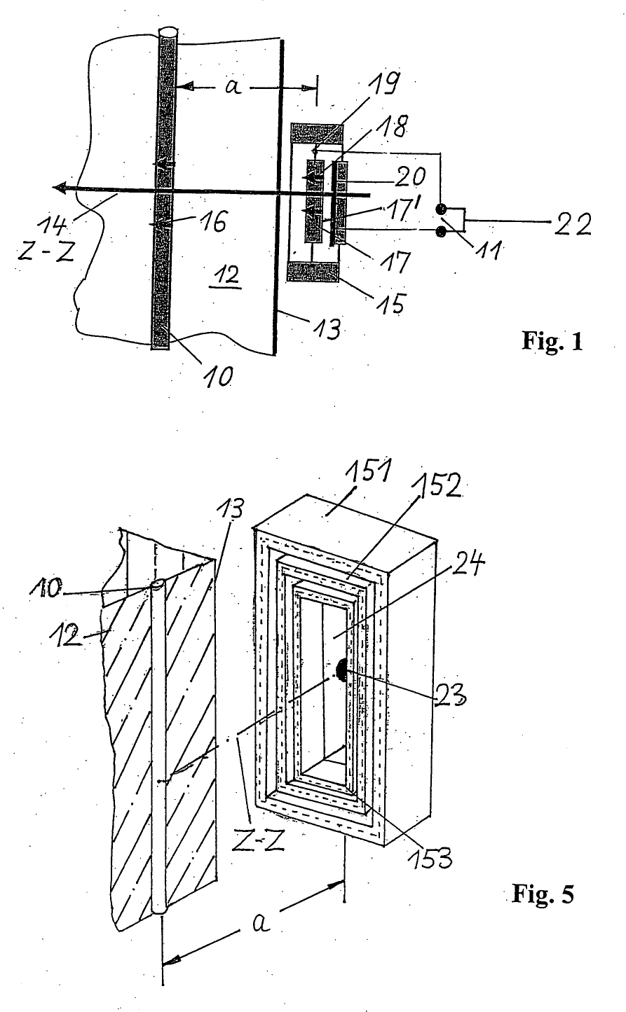

FIG. 1 shows a rod-shaped reinforcing element (object) 10 inside a concrete body (non-magnetic medium) 12 having a concrete surface 13. The primary magnetic field 14 of a current-carrying coil 15 consisting of copper wire magnetizes the rod 10 in dependence on the magnetic field strength. The rod magnetization 16 indicated by arrows generates a stray field that superimposes the primary field 14. The arrow representing the primary field 14 coincides with the geometric axis Z-Z of the coil 15. Both magnetic fields act on a magnetic measuring body 17 in different ways. Whereas the uniform primary field 14 at the position of the measuring body 17 does not apply translatory force although it has a bigger field strength than the stray field, the strongly non-uniform stray field exerts an attractive force onto the measuring body 17, which has been magnetized in the primary field 14, and the arrow-indicated magnetization 18 of said measuring body 17 is oriented parallel to the primary field 14. The attractive force causes the relocation of the measuring body 17 fixed to the coil casing by a flexible holder 19, and the extent of said relocation is measured for example on the basis of the change of the electric capacity of the capacitor 11 that consists of a backplate electrode 20 and the surface 17′ of the measuring body 17. The extent of the relocation reaches its maximum as soon as the distance between the rod 10 and the measuring body 17 reaches its minimum value. In this way, the movement of the coil 15 and the measuring body 17 parallel to the concrete surface allows to locate the rod 10 and make it visible by using an indicating, recording and evaluating unit 22. Said relocation can be measured both by electrical and other physical methods (e.g. optical or acoustic measurements by using ultrasound, etc.). The measuring body 17 can also be positioned in a fluid. The coil 15 generating the magnetic field 14 can have a circular or advantageously rectangular shape and has a corresponding magnetic field distribution. For the latter shape it will be helpful, if the longer edge of the coil 15 runs parallel to the rod 10.

The detection sensitivity of the relocation of the measuring body 17 can be increased by using a measuring body that is made of permanent magnetic material and shows for example a left oriented magnetization, as presented in FIG. 1. As the remanent magnetization of the permanent magnetic material can be much stronger than the magnetization of the soft magnetic measuring body in the primary field 14, the force acting onto the measuring body can be much bigger. Moreover, it is possible to reverse the orientation of the force acting onto the measuring body 17 by reversing the poles of the primary field 14.

The detection sensitiveness can also be increased by switching the primary field 14 on and off in periodic intervals or by changing it periodically or by reversing its poles. When doing this, the number of periods per second selected must almost correspond to half the mechanic frequency of the holder 19 or to the total amount of it and/or of the natural electric frequency of the circuitry used for measuring the change in capacity.

The measurement of the concrete cover can also be improved by using a system of coils that generates a primary field 14, and the maximum on the coil axis Z-Z or the zero crossing can be adjusted and changed at a variable distance to a coil system center plane that has a rectangular orientation towards the coil axis. Thus it is also possible to locate even reinforcing elements separately that are positioned one behind the other because they are strongly magnetized and can be individually recorded on the basis of their force effect onto the measuring body 17.

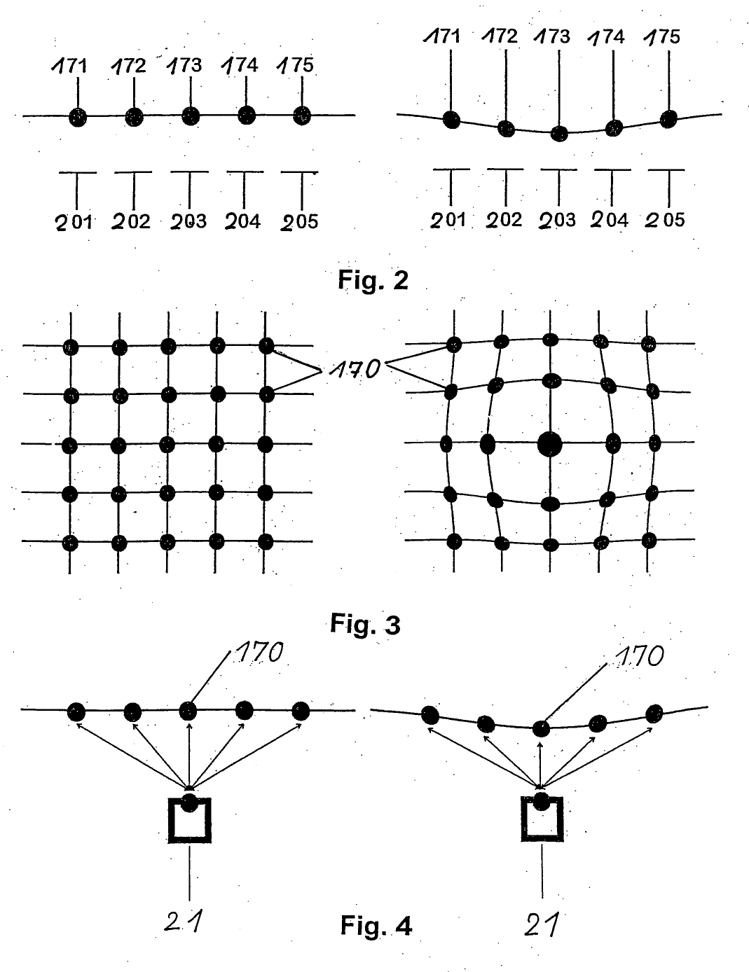

FIG. 2 shows several sensors in linear arrangement including the elements 17, 17′, 19, 20 and 11 in FIG. 1 so that the measuring bodies 171 through 175 are positioned opposite to the electrodes 201 through 205. In this arrangement, the opposite measuring bodies and electrodes belonging to each other can be arranged together within only one coil or also as separated pairs each of them within an individual coil. On the left side of FIG. 2, the measuring bodies 171 through 175 are represented without any stray field influence and on the left side they are shown under the influence of a stray field with a clearly visible relocation of the measuring bodies 172, 173, 174 relative to the electrodes 202, 203, 204. As the local distribution of the stray field depends on the form of the magnetic object to be located, separated measurements of the displacements of the individual measuring bodies point to the form of the object to be located.

FIG. 3 shows a matrix arrangement of the measuring bodies 170 so that all influences of the stray field can be recorded on one plane. By analogy with FIG. 2, the left side shows the arrangement without the influence of a stray field, whereas a clear influence of an active stray field can be seen on the right side.

FIG. 4 clearly demonstrates that several measuring bodies 170 arranged side by side act on a common sensor 21. Said sensor can be designed as a capacitor or as an optic or acoustic sensor.

In FIG. 5, three rectangular coils 151, 152, 153 are arranged within each other coaxially to an axis Z-Z. A magnetometer 23 is positioned on a center plane 24 that is provided parallel to the coil planes and perpendicular to the axis Z-Z. A reinforcement rod 10 is positioned at a distance a to the magnetometer and runs parallel to the long edges of the rectangular coils and to the exterior surface 13 of the concrete body 12. If the coil currents are switched on, a primary field will be generated that magnetizes the reinforcement rod 10 and generates a stray field First, the field starts from the two coils 151, 152. The currents carried by these coils have opposite signs so that the magnetic fields of the two coils are also oppositely oriented. The product N.I resulting from the number of turns (N) and the amperage (I) of the current passing the coils is changed for the smaller coil 152 in such a way that its amount is between 0 and 100% of the corresponding product of the bigger coil 151.

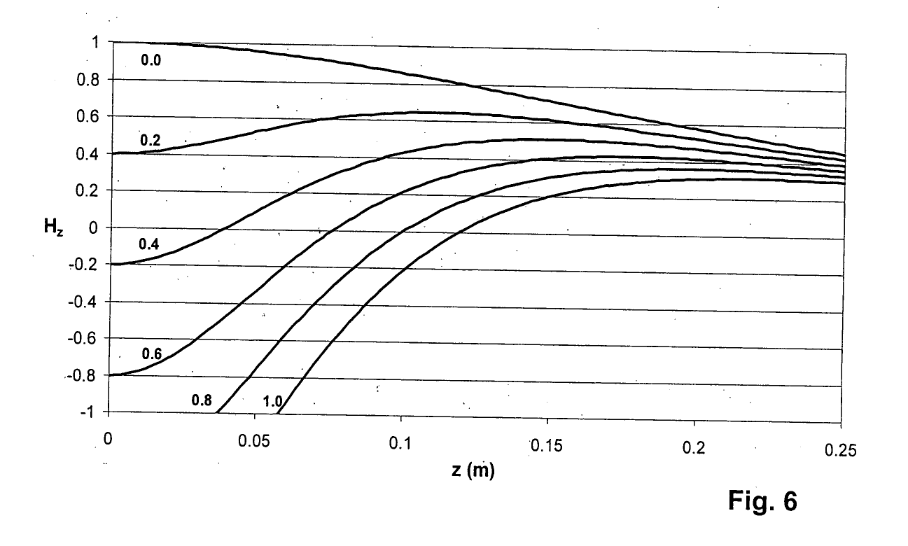

In the diagram of FIG. 6, the quotient hz resulting from the Z component of the primary field of the coils and the magnetic field of the bigger coil, measured in the center of this coil, is plotted as ordinate above the coil axis Z-Z that is plotted as abscissa. FIG. 6 includes an example of two coaxially arranged circular coils with the bigger one having a radius of 30 cm and the smaller one a radius of 10 cm and it is shown how the maximum of the total magnetic field is relocated on the common coil axis Z-Z by changing the product NI of the smaller coil. Moreover, FIG. 6 demonstrates the relocation of the position of the axis at which the total field is more or less zero (zero crossing). The curves 0, 0.2, 0.4, 0.6, 0.8 and 1.0 represent the changes that are caused for 0%, 20%, 40%, 60%, 80% and 100% in the product for the smaller coil 152. The zero crossings of the curves 0.4, 0.6, 0.8 and 1.0 are correspondingly at a distance of about 3.8 cm, 7.5 cm; 10 cm and 12 cm on the Z axis. All positions are measured from the coil center located on the center plane 24 with said coil center being also the position of the magnetometer 23.

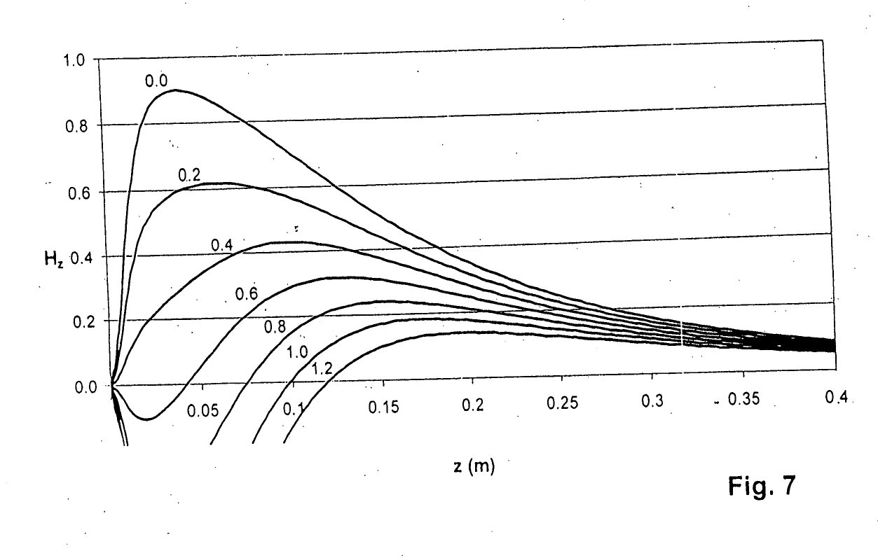

Thanks to these changes it is possible that objects positioned closer to the coil system are magnetized less than objects that are positioned more far away or they are magnetized by a primary field of the opposite sign and thus generate accordingly adjustable stray fields. The additional change of the diameters of the two coils and the involvement of further coils (153) allow to extend the variations of the primary magnetic field. Thus, the use of the third coil (bucking coil) 153 makes it possible to considerably reduce the primary magnetic field in the center of the coil arrangement without considerably changing the field orientation at longer distances to the center. In this way, the magnetosensor 23 arranged in the center is not subject to strong magnetic fields; see FIG. 7.

By analogy with FIG. 6, FIG. 7 shows the orientation of a primary field on the common coil axis Z-Z as a function of the distance Z from the coil center. In this example, the coil system consists of three coaxial circular coils. The biggest coil of them has a radius of 20 cm, the middle one has a radius of 10 cm and the smallest one, that is provided as the bucking coil, has a radius of 1.5 cm. FIG. 7 illustrates that the total primary field at the position of the magnetometer 23 can always be eliminated by adjusting the product N.I of the bucking coil. The relation of the products N.I of the two bigger coils is selected so that further zero crossings of the total primary field are positioned on the axis Z-Z at different distances from the coil center 0. The curves 0, 0.2, 0.4, 0.6, 0.8, 1.0, 1.2 represent the changes that are caused for the maximum of the total primary field by the change in the relation of the products N.I of the two bigger coils. A relation of 60%, 80%, 100%, 120% of the product of the middle coil to the one of the biggest coil leads to distances of 4 cm, 7.5 cm, 10 cm, 12 cm.

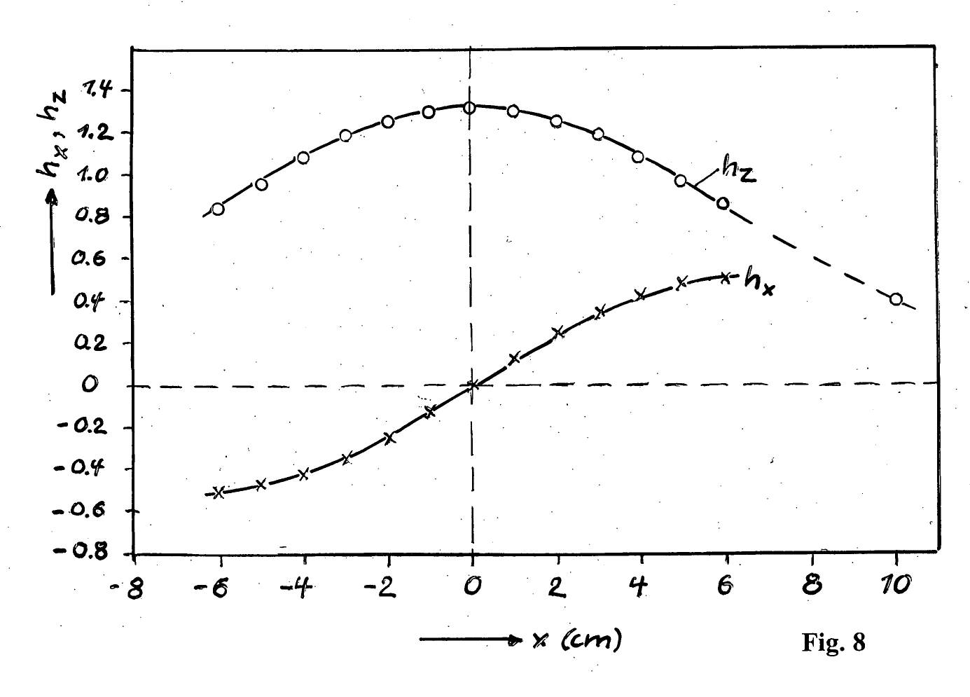

The diagram in FIG. 8 shows how the stray field components measured by the magnetometer 23 change with the movement of the magnetometer 23 parallel to the exterior concrete -surface 13. In this example, the magnetometer 23 is arranged in the center of the coil combination. The abscissa marks the distance x of the rod to the magnetometer on the coil plane perpendicular to the rod (object) 10. On the ordinate, the quotient of the stray field components and the remanent magnetization of the object 10 is plotted and marked by hₓ and h_{z}. The source of the primary field is assumed to be a single rectangular coil the long edges of which are arranged in parallel position to the rod-shaped object 10 and have a length of 50 cm. The shorter edge has a length of 20 cm. The rod-shaped object 10 has a diameter of 1 cm. For the distance a=10 cm between the object 10 and the plane on which the is moved perpendicular to the axis of the object 10 and parallel to the exterior surface 13, a maximum value h_{z} will be reached as soon as the Z-Z axis of the coil intersects the object 10. Thus, the position on the exterior concrete surface under which the object 10 is located will be found, if the magnetometer 23 is moved parallel to the exterior concrete surface 13. In case of a slight lateral relocation from this position, stray field components are measured the signs and values of which indicate the direction into which and the lateral distance by which the magnetometer 23 is relocated relative to the object 10. The coordinate that is perpendicularly oriented both to the Z-Z axis and to the axis of the rod-shaped object 10 is called X axis. The component of the stray field that is parallel to the X axis at the location of the magnetometer 23 will become zero, if the object is positioned on the Z-Z axis. Then, the amount of the Z component of the stray field can be used for the determination of the distance a and of the diameter of the object 10, if the strength of the primary magnetic field is changed in a controlled manner at the position of the object 10. An approximate calculation shows that the Z component of the stray field is proportional to the product of the square object diameter and the primary field strength and decreases with a numerically calculable function of the distance a. As the primary field strength can be changed at the position of the object while the object diameter remains constant, it is possible to determine (e.g. by varying the zero crossing of the primary field) first the distance a and then, on the basis of the known value of a, the object diameter. An appropriate adjustment of the zero crossing of the primary field has the effect that an object positioned in a certain depth does not actually generate a stray field whereas an object positioned deeper exhibits a stray field that can be measured.

All elements presented in the description, the subsequent claims and the drawing can be decisive for the invention both as single elements and in any combination.

### List of Reference Numerals

10 reinforcing element, object, rod

11 capacitor

12 concrete body

13 exterior surface of the concrete body

14 primary magnetic field

15 magnetic field generator, coil, permanent magnet

16, 18 magnetizations

17 measuring body

17′ surface of the measuring body

19 flexible (elastic) holder

20 backplate electrode

21 capacitor, sensor

22 indicating, registering and evaluating unit

23 magnetometer

24 central plane

201, 202, 203, 204, 205 backplate electrodes

151, 152, 153 rectangular coils

170, 171, 172, 173,

174, 175 measuring bodies

X-X, Y-Y, Z-Z axes

a, x distance

0; 0.2; 0.4; 0.6; 0.8;

1.0; 1.2 curves

### Reference Literature

### [1] C. Flohrer “Messung der Betondeckung und Ortung der Bewehrung”, DGZfP-Berichtsband 66-CD der Fachtagung Bauwerksdiagnose—Praktische Anwendungen Zerstörungsfreier Prüfungen v. 21-22 Jan. 1999, Vortrag 4¹

[2] H. Fudo er al. Jap. Patent. 09021786 (1997)
[3] Y. J. Kim & H. G. Moon U.S. Pat. No. 6,414,484 (2002)

### [4] P. A. Gaydecki et al., Measurement Science and Technology 13 (2002) 1327-1335

### [5] G. Miller et al., 42nd Annual British Conf. on NDT (2003) 133-138

### [6] S. Queck et al., NDT&E International 35 (2002) 233-240

### [7] M. Zaid et al. 42nd Annual British Conf. on NDT (2003) 257-262

[8] K. Yamada & T. Amano Jap. Patent 2003014704 (2003)

### [9] M. Woodcock & R. Holt PCT/US95/07160 (1995)

### [10] P. A. Gaydecki & F. M. Burdekin PCT/GB91/01905 (1992)

### [11] M. Schickert, DGZfP-Berichtsband BB 85-CD (2003) 1-11

### [12] H. Chisake & Y. Totoki, Jap Patent 2001041908 (2001)

### [13] C. Florin, D E 197 52 572 (1999)

### [14] R. Göttel et al., ITG-Fachberichte 149 (1998) 193-196

[15] S. Cardimona et al., Geophysics 2000, 1st Int. Conf. on the Application of Geophysical Methodologies and NDT to Transportation Facilities and Infrastructure (2000) 4-23
[16] A. Shaari et al., Insight 44 (2002) 756-758

1. Arrangement for locating magnetic objects or objects that can be magnetized, which are positioned in a non-magnetic media, comprising at least one magnetic field generator providing a primary magnetic field, at least one sensor arranged in the primary magnetic field, the primary magnetic field of the magnetic field generator being a permanent magnetic field and the sensor being surrounded by the magnetic field generator.

2. Arrangement according to claim 1, wherein the magnetic field generator comprises at least one coil.

3. Arrangement according to claim 1, wherein the magnetic field generator comprises coaxially arranged permanent magnets.

4. (canceled)

5. Arrangement according to claim 2 or 3, wherein the sensor is a one-, two- or three-axis magnetometer.

6-15. (canceled)

16. Arrangement according to claim 5, wherein the magnetometer mechanism is based on the Hall effect.

17. Arrangement according to claim 5, wherein the magnetometer is based on the magnetoresistive principle.

18-20. (canceled)

21. Arrangement according to claim 1, wherein several magnetic field generators and sensors are arranged on an area that corresponds to the surface of the medium to be examined.

22. Arrangement according to claims 1 and 21, wherein several magnetic sensors are arranged one behind the other on geometric axes of the magnetic field generators.

23-26. (canceled)

27. Arrangement according to claim 1, wherein the magnetic field generator comprises at least two coils that are arranged coaxially and within each other.

28. Arrangement according to claim 2 or 27, wherein the coils have a rectangular shape.

29. Arrangement according to claim 1, wherein the sensor is a ferromagnetic body that is arranged parallel to the flux lines of the uniform magnetic filed in such a way that it is free to move.

30. Arrangement according to claim 29, wherein the ferromagnetic body is flexibly arranged at the magnetic field generator.

31. Arrangement according to claim 1, wherein the magnetic field of the magnetic field generator can be adjusted.
